(19) United States
(12) Patent Application Publication
(10) Pub. No.: US 2009/0064390 A1
(43) Pub. Date: Mar. 12, 2009

(54) One piece, wearable sleep training system with illuminating section

(76) Inventors: Michelle Jean Beiring, Williamsburg, OH (US); Lois Jane Maines, Hamilton, OH (US)

Correspondence Address: Lois Jane Maines, 3774 Tyler Ridge Ct., Hamilton, OH, 45011, US

(21) Appl. No.: 12/231,505

(22) Filed: Sep. 3, 2008

Related U.S. Application Data
(60) Provisional application No. 60/967,771, filed on Sep. 7, 2007.

(51) Int. Cl. A41D 11/00; A41D 10/00; A41D 1/00; A41D 27/00; F21V 21/00

(52) U.S. Cl. 2/80; 2/83; 2/69; 2/243.1; 362/103

(57) ABSTRACT

A one piece sleep training garment used to progress an infant through three stages of swaddling positions. Stage one will swaddle both arms, stage two will only swaddle one arm and stage three will allow both arms to be free.

Trainer is also equipped with an illuminating section attached onto inside bottom portion, used to assist a caregiver in meeting an infant's needs in low light levels, such as night time.

Trainer further consists of a curved zipped bottom portion which allows it open upward, revealing baby's hind quarters. This allows the caregiver to tend to an infant without disturbing its swaddle so that disruption is minimal.

### CROSS REFERENCE

This application claims benefit to provisional application No. 60/967,771 filed on 7 Sep. 2007.

### REFERENCES CITED (REFERENCED BY)

### U.S. Patent Documents

U.S. Pat. No. 3,739,399 June 1973 Sheahon
U.S. Pat. No. 4,832,214 May 1989 Schrader, et al.
U.S. Pat. No. 4,979,250 December 1990 Troncone, et al.
U.S. Pat. No. 5,046,204 September 1991 Mohler
U.S. Pat. No. 5,129,406 July 1992 Magnusen, et al.
U.S. Pat. No. 5,621,917 April 1997 Howsden
U.S. Pat. No. 5,722,094 March 1998 Ruefer
U.S. Pat. No. 6,009,576 January 2000 Gramme, et al.
U.S. Pat. No. 6,393,612 May 2002 Thach, et al.
U.S. Pat. No. 6,662,390 December 2003 Berger
U.S. Pat. No. 6,676,269 January 2004 Dorney
U.S. Pat. No. 0,139,527 July 2004 Damir, et al.
U.S. Pat. No. 6,817,033 November 2004 Bailey
U.S. Pat. No. 6,839,924 January 2005 Sims
U.S. Pat. No. 7,043,783 May 2006 Gatten
U.S. Pat. No. 7,076,819 July 2006 Trani
U.S. Pat. No. 7,111,344 September 2006 French
U.S. Pat. No. 7,181,789 February 2007 Gatten
U.S. Pat. No. 7,246,392 July 2007 Schmid, et al.
U.S. Pat. No. 7,254,849 August 2007 Fiebrich, et al.

### FIELD OF THE INVENTION

This disclosure describes a one-piece, wearable sleep training system with an illuminating section. More particularly, this disclosure describes a device for sleep training an infant through employing the use of various swaddling positions. This invention is in the general field of infant sleep training garments. Furthermore, this disclosure describes a garment containing an illuminating segment designed to aid caregiver in proper care of infant when light levels prevent satisfactory vision.

### BACKGROUND

Caregivers have swaddled their babies throughout history. “Swaddling is an age-old practice of wrapping infant's snuggly in swaddling cloths, blankets or similar cloth so that movement of the limbs is tightly restricted. Swaddling bands were often used to further restrict the infant.” (http:/twikipedia.ortwiki/swaddling.) It was commonly believed that this was essential for the infant to develop proper posture. As the practice has evolved through modern times, we now know many other important reasons why swaddling an infant is beneficial.

Swaddling has many positive aspects for both infant and mother. It is a generally accepted notion that swaddling an infant allows them to sleep more soundly and safely. The swaddling position is similar to the womb environment where baby's range of motion is greatly restricted within the fetal cavity. By firmly wrapping an infant in a chosen garment, limbs are likewise kept fairly motionless allowing the transition from womb to wrap to occur with little disruption. Securing an infant's arms further subdues its ‘startle reflex’. This reflex is a response to unexpected loud noise. It is believed to be the only unlearned fear in newborn babies. This reflex is characterized by a sudden jolt of the.arms followed by crying. By employing a swaddling garment, caregiver is able to protect infant from this reflex because the arms will not be vulnerable to sudden flailing motions. A swaddle further comforts an infant by placing constant, light pressure on the chest region. Such pressure has been shown to reduce the instance and severity of colic.

Finally, a swaddling position is beneficial because it eliminates the need for a blanket. As an infant tosses and turns during the duration of the night, a loose blanket has the potential to ride up over the mouth and nose, thus suffocating the sleeping baby. In fact, due to the potential health risks associated with using a blanket, many pediatricians are now recommending that children under one year of age sleep without the use of this object, opting instead for a snuggly fitted one-piece garment. Swaddling a baby allows it to stay warm while ensuring that no danger is posed to their health and safety. Experts in the field of SIDS, (Sudden Infant Death Syndrome) recommend sleeping an infant in the supine (on back) position. Sleeping in this manner decreases the likelihood that an infant will fall prey to SIDS. A swaddle ensures that an infant will remain in the supine position because it does not give the limbs the opportunity to flip the baby onto its other side.

Despite the numerous benefits to swaddling some problems still remain. A baby that has been trained to sleep only in a swaddled position may have difficulty sleeping un-swaddled once age dictates it is time to do so. Transitioning from a full swaddle to no swaddle at all may be emotionally difficult for caregiver and infant alike. A method of slow progression would address this problem and allow an infant to transition through the stages of sleep independence. Additionally, a tight swaddle around the hip and leg areas of the infant distorts the natural positioning of the human form. Tightly wrapping an infant in this way can potentially lead to hip dysplasia and other medical conditions.

A swaddled position also makes it difficult for a caregiver to properly meet the infant's needs when the infant awakes. Bound in tight layers of cloth and given limited vision, a caregiver has to perform the time-consuming task of intricately unwrapping and rewrapping the infant with little to no light to guide them. After such an extensive ordeal, the infant may have extreme trouble falling back to sleep.

### DESCRIPTION OF RELATED ART

Many inventors throughout history have recognized the importance of the swaddling art form. Given the need to provide newborns with protective, practical and comfortable sleepwear, many prior attempts have been made to suitably reach this goal.

Numerous swaddling devices have been proposed by previous inventors that aim to secure an infant through the use of a flat cloth folded or wrapped around the infant's limbs. Examples are disclosed in U.S. Pat. No. 7,043,783 to Dean, and in U.S. Pat. No. 7,076,819 to Trani et al. Each of these patents describe a piece of cloth that is tucked or folded around the infant to secure its limbs. These inventions succeed at securing the infant, but fail to meet the safety standards commonly recommended by pediatricians. They are loose garments that have the potential to come un-swaddled during the course of the night and suffocate the sleeping infant. They further fail to provide a method by which to train an infant to successfully sleep without the aid of a swaddling blanket. Finally, they do not allow free movement of the hips and legs which can cause health problems such as hip dysplasia.

Others have developed wearable sleep blankets that solve the previous problems described above; such is the case of U.S. Pat. No. 7,246,392 to Schmid et al. They propose a wearable sleep blanket and a swaddling blanket thereafter. This invention, while safer than the last, fails to address the need to sleep train an infant out of the swaddling practice. Furthermore, this proposal fails to meet the criteria of being a one-piece garment. Several pieces must be used in conjunction with one another to make the claims successful. Extra items and fastening devices can be burdensome to execute and difficult to keep track of.

Still others have developed a one-piece swaddling system that aims to receive one arm respectively on either side of the infant's body via a small pouch sewn into the fabric. These pouches are to be able to securely restrain an infant's arms while the legs are free to move about in the body of the garment. U.S. Pat. No. 6,393,612 to Thach et al. demonstrates this invention. This however, likewise fails to provide a method by which caregivers may effortlessly transition the infant out of the swaddling position. It furthermore has many complicated fastening mechanisms which can be difficult to maneuver at night when lighting is not available.

Together with several other pieces of art in this field, inventors have tried to create a swaddling device that safely secures an infant during the sleeping process. None however, have been successful at creating a sleep training system that teaches new caregivers how to transition a baby out of the swaddling position once age dictates it is necessary to do so. Pediatricians recommend that infants be broken slowly from the swaddling position. Transitioning from a full swaddle to no swaddle at all can be emotionally difficult for both infant and caregiver. Thus, it is necessary to create a garment that allows slow transitioning from one stage to the next. This can be achieved through an intermediary sleep position consisting of swaddling one arm while allowing the other to adjust to being loose. Once the infant is acclimated to this position, both arms may be easily loosed allowing infant to sleep independent of a swaddle without shocking them with a rapid training progression.

Furthermore, no other one-piece wearable garment has addressed the issue of possible lighting deficiencies as it relates to properly caring for an infant during the timetable that the product is designed to function under. Sleep garments are purposed to be used at night. No invention in this field has sought to include an illuminating section in conjunction with their garment to allow the caretaker to properly meet the needs of the newly awakened infant.

Thus, it would be advantageous in the art to provide a one-piece wearable sleep training system with an illuminating segment. This artwork would address all the known complications associated with infant sleep training.

### SUMMARY

A wearable one-piece sleep training system that enables a caregiver to effortlessly transition an infant through various levels of restraint. Furthermore, it is a sleep trainer that includes, but is not limited to having, a segment on the lower region of the garment for the purpose of illumination. Said illumination will be used for the purpose of assisting the caregiver in suitably meeting various needs during the course of the night when light levels do not accommodate good vision. Garment will further serve to reenact the conditions of the womb by offering a similar environment to that found within the mother's body. Conditions to fulfilling that requirement include: material choice, direction of fabric flexibility and general shape and size of the encasement. Garment is set forth to be one piece making for easy mobility. Garment is also intended to be made of a material that allows maximum stretch with minimal fabric. This will allow garment to be small enough to easily fit into a purse, diaper bag or any other location by means of its size and consistency. The garment will be transitional allowing caregiver to position an infant in numerous ways and with varying degrees of restraint in order to successfully train the baby to eventually sleep on its own. Once garment has fulfilled its function of training the infant to sleep, it may be worn as its own individual garment that does not necessarily fulfill the purpose of transitioning the infant. Finally, garment is to have an open bottom portion that fastens closed via a zipper. This opening will allow a caregiver to access the infant's lower body without disturbing its ‘swaddled’ upper body. Thus, the caregiver may meet the needs of the infant without causing the infant to awake or become startled.

### BRIEF DESCRIPTION OF DRAWINGS

FIG. 1 illustrates a closed view of the front side of the sleep training system.

FIG. 2 illustrates a closed view of the rear side of the sleep training system.

FIG. 3 illustrates a closed view of the front side of the sleep training system with bottom portion open.

FIG. 4 illustrates an open view of the back panel of the sleep training system.

FIG. 5 illustrates an example of an infant in a ‘full swaddle’ position in the sleep training system.

FIG. 6 illustrates an example of an infant in a ‘half swaddle’ position in the sleep training system.

FIG. 7 illustrates an example of an infant in a ‘no swaddle’ position in the sleep training system.

### DETAILED DESCRIPTION OF THE INVENTION

A one-piece wearable sleep training system with an illuminating segment. The sleep trainer is equipped with two flexible bands that allow an infant to be securely swaddled when bands are placed across infant's body. More specifically, band has a ‘full swaddle’ position in which it is placed over both of infant's arms securing the arms next to the side body. Band may also be used for the ‘half swaddle’ position in which it is placed over one of the infant's arms, securing that arm next to the side body while the other arm is free to extend out of the garment via the provided arm opening. Finally, band may be used for the ‘no swaddle’ position in which both arms will extend out of the garments provided arm openings. In this way, sleep training garment will be worn as a regular garment free from any swaddling restraints.

Sleep training system is further equipped with an illuminating segment on the inside bottom portion of the garment. This illuminating device is intended to give visual aid to a caretaker as they tend to an infant in low light levels.

Sleep training system is also to include a zipper along the lower portion of the garment that will provide access to the infant's lower body when it is opened.

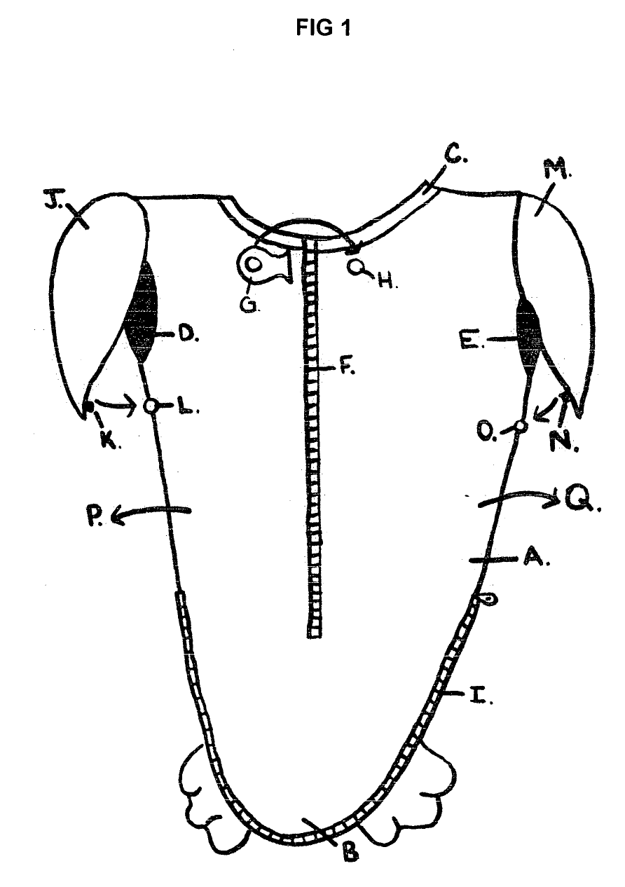

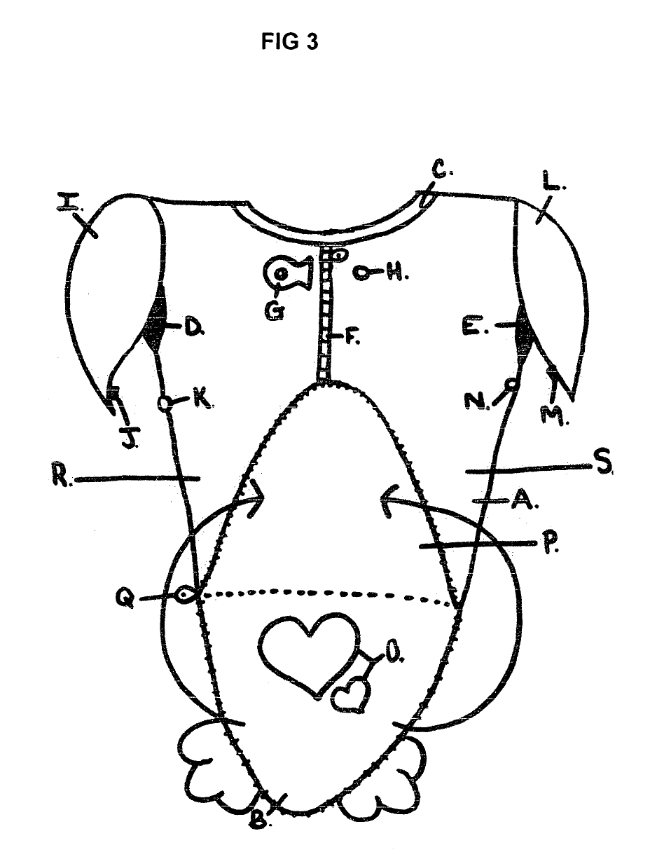

With regard to ‘FIG. 1’, a closed view of the sleep training system is provided. The wearable garment (A) is a garment that fully encloses both legs of an infant in a singular compartment. The garment consists of a front ‘FIG. 1’, a closed bottom (B), two arm holes (D) and (E) and a neck hole (C). Garment is divided into portions (P) and (Q) via a zipper that allows infant to be received into it. The closing mechanism (F) ‘the zipper’ extends from the neck opening down to the near bottom portions of the garment; thus acting as a connection between the left and right segments (P) and (Q) of the garment. A protective flap (G) is sewn into garment over top portion of zipper (F) and fastened over zipper (F) via fastener (H) to protect infant from possible contact with zipper pulley mechanism. When connective zipper (F) is close to lower portion of garment, portions (P) and (Q) may be peeled back to reveal open view of garment as seen in ‘FIG. 3’. When portions (P) and (Q) are peeled back, an infant may be welcomed into sleep garment (A). Two attached arm hole coverings (J) and (M) may be fastened via (K) and (N) to corresponding fasteners (L) and (O) in order that garment is sealed while infant is utilizing the ‘full or half swaddle’ positions of the sleep training system. A zipper mechanism (I) is located at the bottom portion of garment (A) so that when zipper is open, access is given to infant's lower body.

Garment (A) may be made of any material suitable for infant wear. Material should consist of horizontally stretching fibers that seek to resemble flexibility of womb environment. Examples are not confined to, but may include cotton, polyester or fleece. Additionally, Figures (J) and (M) may likewise be composed of any material suitable for use in infant wear.

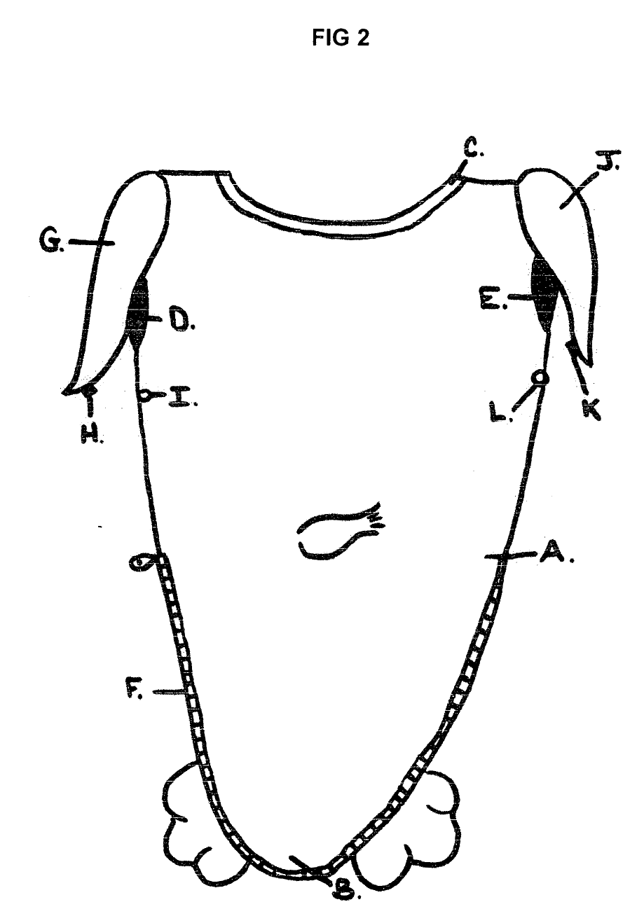

As shown in ‘FIG. 2’, the back of the sleep training system (A) is described from a closed view. The training system (A) consists of two arm holes (D) and (E), a neck hole (C) and a closed bottom segment (B). Two attached arm hole coverings (G) and (J) may be fastened via (H) and (K) to corresponding fasteners (I) and (L) in order that garment is sealed while infant is utilizing the ‘full or half swaddle’ positions of the sleep training system. A zipper mechanism (F) is located at the bottom portion of garment (A), so that when zipper is open, access is given to infant's lower body.

As shown in ‘FIG. 3’ a closed front view of the sleep training system is shown with the bottom segment in its open position. Garment (A) has an open bottom (B), two arm holes (D) and (E) and a neck hole (C). Garment is divided into portions (R) and (S) via a zipper (F) that when unzipped allows an infant to be received into it. A protective flap (G) is sewn into garment (A) and fastens over zipper (F) via fastener (H) to protect infant from possible contact with zipper pulley mechanism. Two attached arm hole coverings (I) and (L) may be fastened via (J) and (M) to corresponding fasteners (K) and (N) in order that garment (A) is sealed while infant is utilizing the ‘full or half swaddle’ positions of the sleep training system. Zipper (Q) is shown in an open position which allows flap (P) to be peeled up to reveal infant's lower body.

Sleep training garment (A) will also contain an illuminating segment (O). Segment is to be made of any material suitable for use in infant wear. Segment (O) will serve as a glow in the dark visual aid that will assist caregiver in meeting infant's needs during times of limited visibility. An example would be at night when light levels are too low for caregiver to properly see infant. Segment (O) should be a size that is respective to the overall size of the garment (A). An example would be an illuminating segment that measures four inches by four inches in dimension.

Sleep training garment (A) is to be fitted relative to the size of the infant it is suggested for. Garment (A) is to fit snuggly yet comfortably around the entire girth of the infant to provide ample stretch. For example, garment (A) should resemble the flexibility of the mother's womb. Garment (A) should further consist of a lower portion (B) that acts as a ‘sac’ for infants legs. Legs should be relatively free within the ‘sac’ to allow optimal movement. Lower portion (B) should only allow enough mobility that infant may move limbs, but not so much as would be expected if infant we in no enclosure at all.

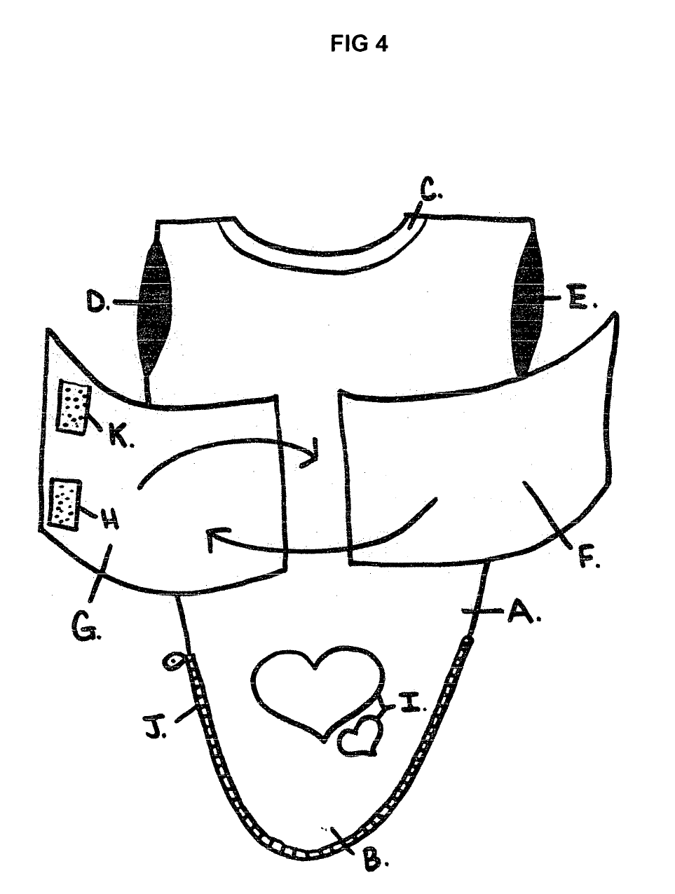

Sleep training garment (A) is to be comprised of a neck opening (C). Opening is to be the proper circumference to receive the head and neck portions of an infant. Opening (C) is to be comprised of any stretchy material suitable for use in infant wear. ‘FIG. 4’ describes the open view of the back panel of the sleep training system. Garment (A) has a bottom portion (B), a neck opening (C) and two arm hole openings (D) and (E). Garment (A) further consists of zipper (J), that when open allows access to an infant's lower body. Flexible bands (G) and (F) are to be attached to garment (A) near the center portion of the back panel and used for the purpose of swaddling an infant. Flexible bands (G) and (F) will be stretched over infant's arm(s) snuggly enough to secure the arm found underneath it. Adjustable, flexible band (G) will then be stretched over infant's other arm(s) snuggly enough to secure the arm found underneath it. Band (G) is designed to engage band (F) via fasteners (H) and (K). Fasteners (H) and (K) may be attached to band (F) anywhere on band's (F) surface to allow maximum restraint and flexibility. Bands (G) and (F) may be made of any material approved for use in infant wear. Illuminating segment (I) is shown on the lower portion of garment (A) and is used as a visual aid when light levels are low. An example would be changing an infant's diaper at night when it is dark.

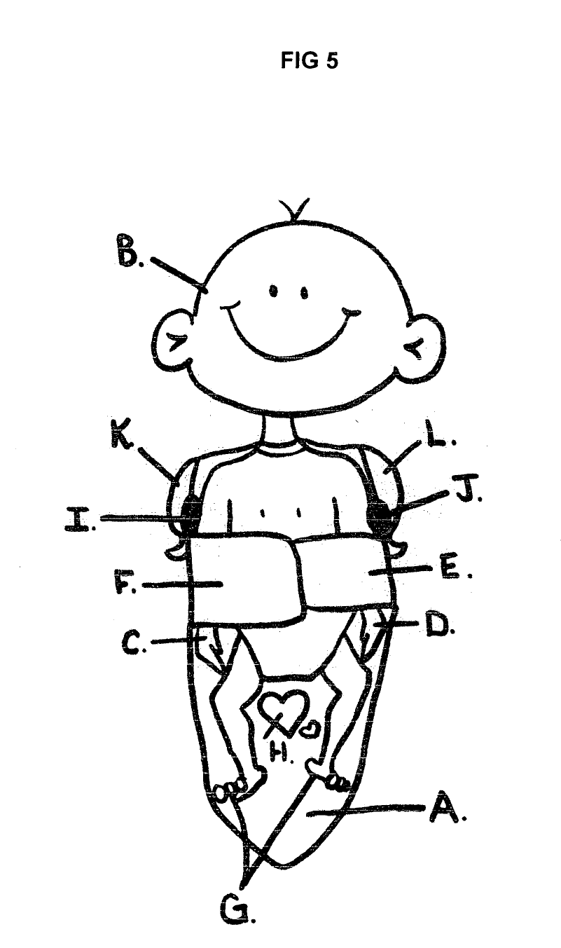

‘FIG. 5’ describes an example of an infant utilizing the ‘full swaddle’ sleep position. In this illustration, the sleep trainer (A) is shown from an open view. Infant (B) is having his arms (C) and (D) secured by bands (F) and (E), keeping his arms (C) and (D) secured to his body. Infant (B) has his legs (G) free within the cavity of the garment (A). Illuminating segment (H) is positioned directly underneath infant's (B) bottom. This could be used, but is not necessarily limited to being used, for aid during diaper changes. Protective flaps (K) and (L) are fastened shut to cover arm holes (I) and (J) in order to protect the infant from the outside environment.

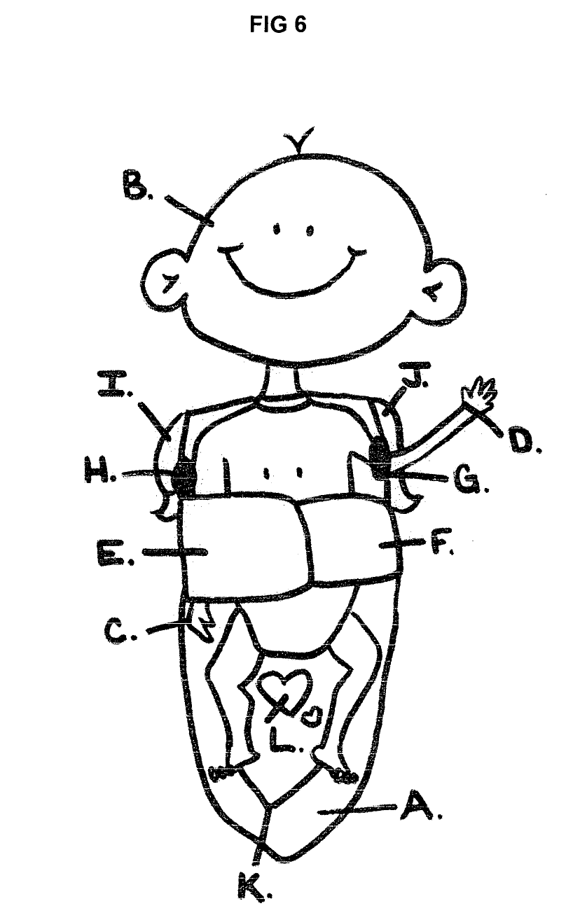

‘FIG. 6’ describes an example of an infant utilizing the ‘half swaddle’ sleep position. In this illustration, the sleep trainer (A) is shown from an open view. Infant (B) is having arm (C) restrained by bands (E) and (F) while arm (D) is free to move outside of arm hole (G). Illuminating segment (L) is positioned directly underneath infant's (B) bottom. lnfant's legs (K) are free to move within the body of the garment. Protective flap (I) is fastened shut to cover arm hole (H) while protective flap (J) is open to allow arm (D) to extend freely through arm hole (G).

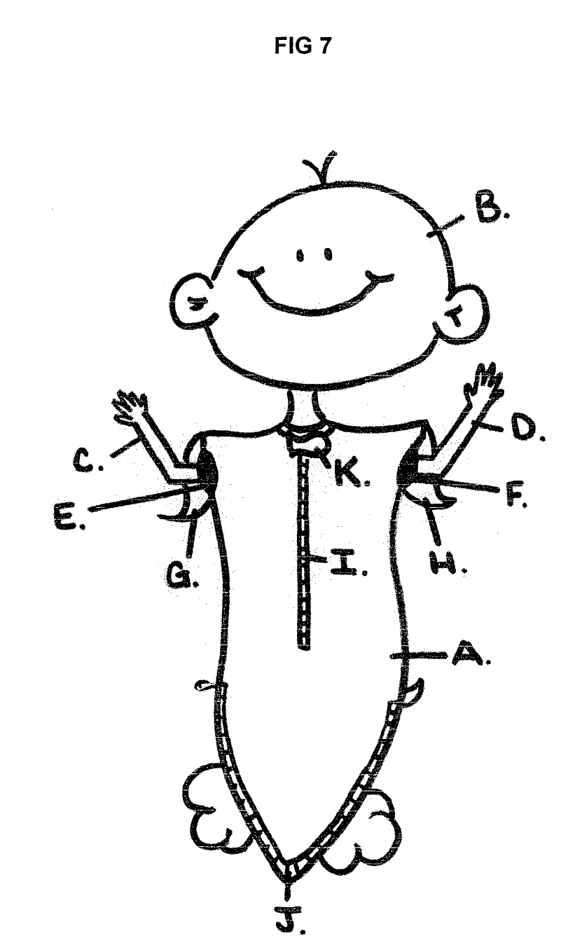

‘FIG. 7’ describes an example of an infant (B) utilizing the ‘no swaddle’ sleep position. In this illustration, the sleep trainer (A) is shown from a closed view. Infant (B) has both arms (C) and (D) free via arm holes (E) and (F). Infant's legs (not shown) are still free to move within the cavity of the garment (A). Garment is fully closed via zipper (I) and covered via flap (K). Flap (K) should be only large enough to cover the standard size of a zipper pulley. For example, flap (K) should be no longer than 2 inches and no wider than 0.5 inches in dimension. Flap (K) is to prevent infant's skin from coming into direct contact with zipper (I). Garment (A) is to be sized according to the needs of the age group it is marketed to. For example, a preemie garment will be smaller than a newborn garment. Garment should begin at infant's neck and extend to no more than six inches below the tips of the infant's toes. Zipper (J) is pulled to its closed position in order to encase the infant's legs. Protective arm flaps (G) and (H) are left in an open position so that arms (C) and (D) may be placed outside of garment (A).

### Direction for Using the Invention

### A) Full Swaddle Position:

Garment will be unzipped and infant will be placed back-side down onto garment surface. The two adjustable bands.will be snuggly attached across infant's arms and over infant's chest, thus securing both arms to the infant's side body. Garment will then be zipped up, protective arm flaps will be secured over arm hole openings and child may be laid down for a sound night's sleep.

### B) Half Swaddle Position:

Garment will be unzipped and infant will be placed back-side down onto garment surface. The arm intended to be un-swaddled may be extended out of the provided arm hole to allow it free movement. The two adjustable bands may then be snuggly attached across the other arm and over the chest, thus securing that arm to the infant's side body. Garment will then be zipped up and the protective arm flap on the swaddled arm side will be secured over arm hole opening. Infant may then be laid down for a sound night's sleep. This method of sleeping the infant with one arm swaddled and one arm free is a recommended method by which a child may learn to sleep independently from the swaddling position.

### C) No Swaddle Position:

Garment will be unzipped and band may be stretched and attached across the sleep training garment under the infant; or, band may be stretched and attached over infant's chest. Depending on chosen position, infant will inevitably have both arms placed outside of garment. In this way, garment will function as a simple pajama or wearable outfit. Garment will then be zipped up and child may be laid down for a sound night's sleep.

The invention claimed is:

1. A one-piece, wearable sleep training system with an illuminating section consisting of an elongated piece of material with a top portion for receiving a head and a bottom portion for receiving the feet, with a length directly in correlation to the distance found therein; having a sac portion for the legs with an open bottom edge fastened by a zipper mechanism, a partially closed top portion with an opening to receive the head, and two adjacent side segments partially closed with an opening through which the arms can extend; having a front portion with an opening and a closing mechanism that connects two front panels; and having a flap on front panel to cover closing mechanism once it is utilized; and having a total body measurement where widest portion is no more than 12 inches, with an overall appearance of an outer shell encasing an inner portion with a swaddling mechanism.

2. A one-piece, wearable sleep training system with an illuminating segment consisting of an interior section comprised of two adjustable bands for swaddling, running horizontally across garment body; and being stitched near center of back panel, positioned directly beneath arm hole openings, and extending horizontally, ending at the approximate location of intended wearer's wrist, and having an illuminating segment on lower portion of interior garment not to exceed four inches by four inches in measurement.

3. A one-piece, wearable sleep training system as set forth in claim 1 further consisting of a garment fabric that stretches horizontally similar to the properties of a mother's womb.

4. A one-piece, wearable sleep training system as set forth in claim 3 that further consists of any material approved for infant wear, including but not limited to cotton, polyester or fleece, so that maximum horizontal stretch of set forth garment may be achieved.

5. A one-piece, wearable sleep training system as set forth in claim 1 further consisting of a total circumference only slightly greater than the circumference of the intended wearer, so that garment is securely and firmly resting upon intended wearer's body frame.

6. A one-piece, wearable sleep training system as set forth in claim 2 consisting of two adjustable bands for swaddling, having a fastening mechanism on one pre-designated band designed to engage at any location with second band in order that a tight ‘swaddle’ may be achieved.

7. A one-piece wearable sleep training system as set forth is claim 6 consisting of two adjustable bands for swaddling, being comprised of any material approved for use in infant wear, with each having a measurement of no more than fourteen inches, but no less than five inches in vertical length, and each having a measurement of no more than sixteen inches, but no less than four inches in horizontal length, so that firm ‘swaddle’ may be achieved.

8. A one-piece wearable sleep training system as set forth in claim 6 consisting of two adjustable bands for swaddling, being positioned directly level with the chest and arm segments of the intended wearer, and directly beneath the provided arm openings, so that band is positioned low enough as to ensure no contact will be made with infants nose and mouth regions.

9. A one-piece wearable sleep training system as set forth in claim 6 consisting of two fastening mechanisms vertically aligned with regard to one another, not to be positioned more than one inch apart, fastened directly to under portion of specified band, including but not limited to Velcro, a button, or a snap, each not to exceed a total area of five inches in height, and three inches in width.

10. A one-piece wearable sleep training system as set forth in claim 1 whereby bottom portion of garment is set forth to be fastened with a zipper mechanism running along the lower segment, with a minimum length of six inches, but not to exceed twenty-four inches, so that intended wearer's hind quarters may be made accessible via said opening.

11. A one-piece wearable sleep training system as set forth in claim 1 whereby garment is equipped with two coverings, each designed to enclose garment's arm openings, each being located above top portion of arm hole openings, having a length not to exceed seven inches, and a width directly proportional to width of arm hole openings, not to exceed six inches, and a fastening mechanism on lower portion designed for engagement with corresponding fastener attached to garment body directly underneath arm hole openings on exterior garment surface.

12. A one-piece wearable sleep training system as set forth in claim 11 whereby fastening mechanisms may be of any variety of fasteners, including but not limited to snaps, Velcro, zippers, or buttons.

13. A one-piece wearable sleep training system as set forth in claim 2 containing an illuminating segment that may or may not be attached or used as a detachable feature, not to exceed four inches by four inches in total face area, and comprised of any material approved for use in infant wear.

14. A one-piece wearable sleep training system as set forth in claim 14 further being set forth to appear on the lower section of the garments interior panel for use as a visual aid as seen fit by caregiver.
